(19) United States
(12) Patent Application Publication
(10) Pub. No.: US 2012/0310379 A1
(43) Pub. Date: Dec. 6, 2012

(54) PROGRAMMABLE CONTROLLER

(75) Inventor: Yasuhiko Chiba, Chiyoda-ku (JP)

(73) Assignee: MITSUBISHI ELECTRIC CORPORATION, Chiyoda-ku, Tokyo (JP)

(21) Appl. No.: 13/577,714

(22) PCT Filed: Feb. 12, 2010
(86) PCT No.: PCT/JP2010/052081

§ 371 Date: Aug. 8, 2012

(51) Int. Cl. G05B 19/048

(52) U.S. Cl. 700/79

(57) ABSTRACT

A PLC includes a detachable first storing unit configured to store first key data and protected from access, a second storing unit configured to store a user program in association with second key data, and a startup processing unit configured to execute startup processing for the PLC itself when a power supply is turned on. The startup processing unit includes a startup-processing-stop determining unit configured to read out the first key data stored by the first storing unit inserted in the PLC itself and the second key data stored in the second storing unit and associated with the user program and determine, based on collation of the read-out two key data, whether the startup processing is continued or the startup processing is stopped and abnormal processing is executed.

### FIELD

The present invention relates to a programmable controller (hereinafter simply referred to as PLC) that controls an industrial machine based on a user program and a programming apparatus that creates the user program.

### BACKGROUND

After being shipped by a PLC manufacturer, a PLC is incorporated in an industrial machine by an apparatus manufacturer and set in a factory of an end user. A user program for causing the PLC to execute the control of the industrial machine is created by the apparatus manufacturer using a programming apparatus and written in the PLC. In general, various technical contrivances are applied to the user program by the apparatus manufacturer to enable the industrial machine, in which the PLC is incorporated, to execute a technically sophisticated operation. The performance of the user program affects a product value of the industrial machine provided to the end user by the apparatus manufacturer or the PLC incorporated in the industrial machine.

However, if the end user or an outsider other than the end user can read out the user program from the PLC, can copy the user program, and can incorporate the copied user program in an empty PLC, the end user or the outsider can create, without difficulty, as many PLCs as possible that perform equivalent control. This prevents legitimate enjoyment of a benefit of the apparatus manufacturer. Therefore, it is demanded to provide in the PLC a mechanism for preventing PLCs, which perform the equivalent control, from being duplicated in an unauthorized manner.

For example, Patent Literature 1 discloses a technology for setting a predetermined address of an input and output memory where hardware peculiar data appears, as a first operand of a general-purpose comparison command, setting hardware peculiar data of a PLC a protection target program section of which is desired to be operated, as a second operand of the general-purpose comparison command, and enabling the protection target program section to be executed using an execution result of the general-purpose comparison command as an input condition. With this technology, the apparatus manufacturer determines an address serving as the first operand and keeps the address secret, whereby the apparatus manufacturer can enable only a specific PLC prepared by the apparatus manufacturer to execute a user program created by the apparatus manufacturer.

### CITATION LIST

### Patent Literature

Patent Literature 1: Japanese Patent Application Laid-Open No. 2009-70144

### SUMMARY

### Technical Problem

On the other hand, on the end user side, there is a demand that, when a PLC has broken down, the end user desires to replace the broken PLC with an auxiliary PLC and resume the operation of an industrial machine as quickly as possible. However, with the technology of Patent Literature 1, a user program of the broken PLC can be operated only on a PLC in which the same hardware peculiar data is set in an address same as an address of the broken PLC. Therefore, an auxiliary PLC has to be prepared for each PLC or, otherwise, the end user has to make contact with the apparatus manufacturer and acquire a PLC for replacement. As a result, there is a problem in that maintainability is poor for the end user.

Besides the technology of Patent Literature 1, to prevent unauthorized duplication, it is also conceivable to manage authority for reading out a user program from a PLC by using a password protection. However, with this technology, unauthorized duplication cannot be prevented when the password leaks from the end user. Nevertheless, if the end user makes password management stricter, the maintainability is sacrificed.

The present invention has been devised in view of the above and it is an object of the present invention to obtain a PLC and a programming apparatus that have as high maintainability as possible and can prevent unauthorized device duplication.

### Solution to Problem

There is provided programmable controller (PLC) that controls an industrial machine based on a user program, the programmable controller comprising: a detachable first storing unit configured to store first key data and protected from access; a second storing unit configured to store the user program in association with second key data; and a startup processing unit configured to execute startup processing for the PLC itself when a power supply is turned on, wherein the startup processing unit includes a startup-processing-stop determining unit configured to read out the first key data stored by the first storing unit inserted in the PLC itself and the second key data associated with the user program stored in the second storing unit, and to determine, based on collation of the read-out two key data, whether the startup processing is continued or the startup processing is stopped for abnormal processing to be executed.

### Advantageous Effects of Invention

According to the present invention, there is an effect that a PLC has as high maintainability as possible and can prevent unauthorized device duplication.

### BRIEF DESCRIPTION OF DRAWINGS

FIG. 1 is a diagram for explaining a state in which unauthorized PLC duplication can be prevented.

FIG. 2 is a diagram for explaining that high maintainability is provided.

FIG. 3 is a diagram for explaining a hardware configuration of a PLC according to an embodiment of the present invention.

FIG. 4 is a diagram for explaining a functional configuration of the PLC according to the embodiment of the present invention.

FIG. 5 is a diagram for explaining a hardware configuration of a programming apparatus according to the embodiment of the present invention.

FIG. 6 is a diagram for explaining a functional configuration of the programming apparatus according to the embodiment of the present invention.

FIG. 7 is a flowchart for explaining first key data setting processing.

FIG. 8 is a flowchart for explaining second key data setting processing.

FIG. 9 is a flowchart for explaining PLC startup processing.

### DESCRIPTION OF EMBODIMENTS

An embodiment of a programmable controller and a programming apparatus according to the present invention is explained in detail below based on the drawings. The present invention is not limited by the embodiment.

### Embodiment

In an embodiment of the present invention, to have high maintainability and make it possible to prevent unauthorized PLC duplication, a PLC is inserted with a key storage device that stores first key data not disclosed to an end user and prohibited to be accessed by the end user and is configured to store a user program associated with second key data corresponding to the first key data and not to complete startup processing for the PLC itself unless a result of collation of the first key data and the second key data is OK. First, to facilitate understanding, characteristics of the embodiment of the present invention are schematically explained. In the following explanation, it is assumed that a collation result is determined as OK when the first key data and the second key data are the same.

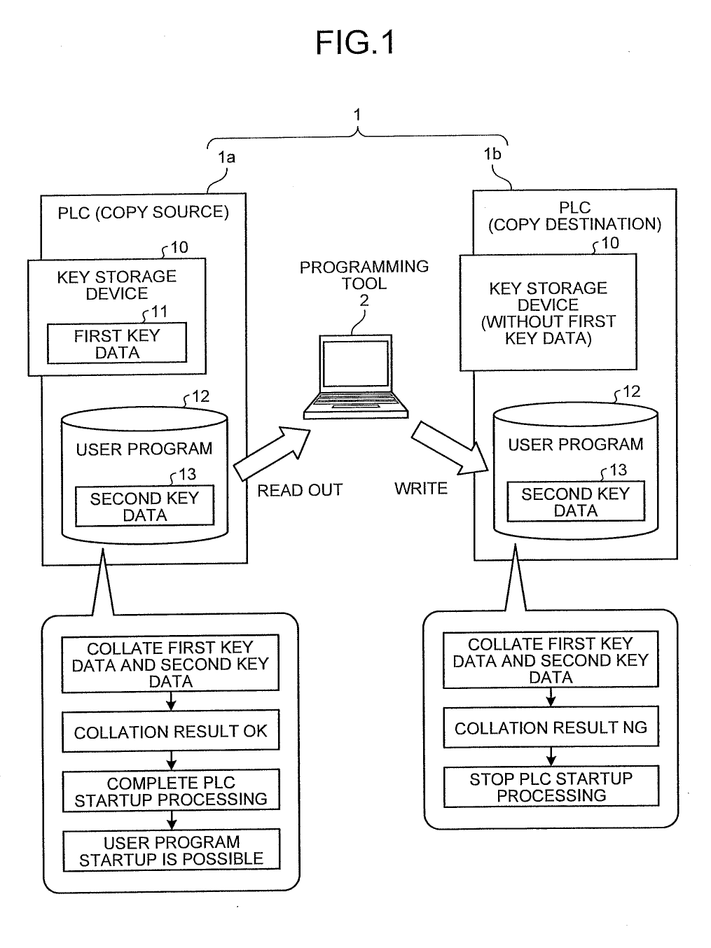

FIG. 1 is a diagram for explaining a state in which unauthorized PLC duplication can be prevented by the embodiment of the present invention. In the following explanation, a user program 12 is read out from a PLC (a PLC 1a) prepared by an apparatus manufacturer and the read-out user program 12 is written in an empty PLC (a PLC 1b), whereby the PLC 1b is caused to perform control equivalent to control by the PLC 1a. The PLC 1a and the PLC 1b (hereinafter generally referred to as PLC 1) are inserted with key storage devices 10, which are detachable storage devices and include a mechanism for disabling an end user to access. The apparatus manufacturer writes in advance first key data 11, which is data undisclosed to the end user, in the key storage device 10 of the PLC 1a and embeds in advance second key data 13, which is data having the same value as the first key data 11, in the user program 12.

When a power supply is turned on, as a part of PLC startup processing including a check of a storage area included in the PLC 1, the PLC 1 collates the first key data 11 and the second key data 13 and determines whether both the key data coincide with each other. When both the key data coincide with each other, the PLC 1 executes the PLC startup processing to the last and shifts to a state in which a user program can be started up. When a RUN instruction is input in this state, the PLC 1 starts up the user program 12. When the first key data 11 and the second key data 13 do not coincide with each other, the PLC 1 stops the PLC startup processing.

In the case of FIG. 1, in the PLC 1a which is a copy source of the user program 12, the first key data 11 and the second key data 13 coincide with each other (collation result OK). The PLC startup processing is completed without trouble and the PLC 1a shifts to a state in which the user program 12 can be started up. On the other hand, in the PLC 1b which is a copy destination of the user program 12, when the key storage device 10 inserted in the PLC 1a is not inserted and the power supply is turned on, the first key data 11 and the second key data 13 do not coincide with each other (collation result NG). The PLC 1b stops the PLC startup processing and does not shift to a state in which the user program 12 can be started up.

A configuration for executing the collation of the first key data 11 and the second key data 13 at timing when the RUN instruction is input, or a configuration for executing the collation after the user program 12 is started up as in the technology disclosed in Patent Literature 1 are conceivable. However, in the embodiment of the present invention, the collation is performed during the PLC startup processing in order to make it difficult to decode the first key data 11 and the second key data 13 through reverse engineering.

As in the technology disclosed in Patent Literature 1, when a general-purpose comparison command for collating key data is included in the user program 12, it is possible to use a duplicated user program 12 in an unauthorized manner by deleting the general-purpose comparison command from the user program 12. However, in the embodiment of the present invention, the collation of key data is not performed based on the user program 12. Therefore, even if a position where the second key data 13 is embedded is found and the second key data 13 is deleted, because a collation result will become to be NG, it is possible to prevent unauthorized use of the user program 12.

As explained above, according to the embodiment of the present invention, the user program 12 is difficult to be executed unless the key storage device 10 prepared by the apparatus manufacturer is present. Therefore, it is possible to prevent a large number of the PLCs 1, which execute equivalent controls, from being duplicated.

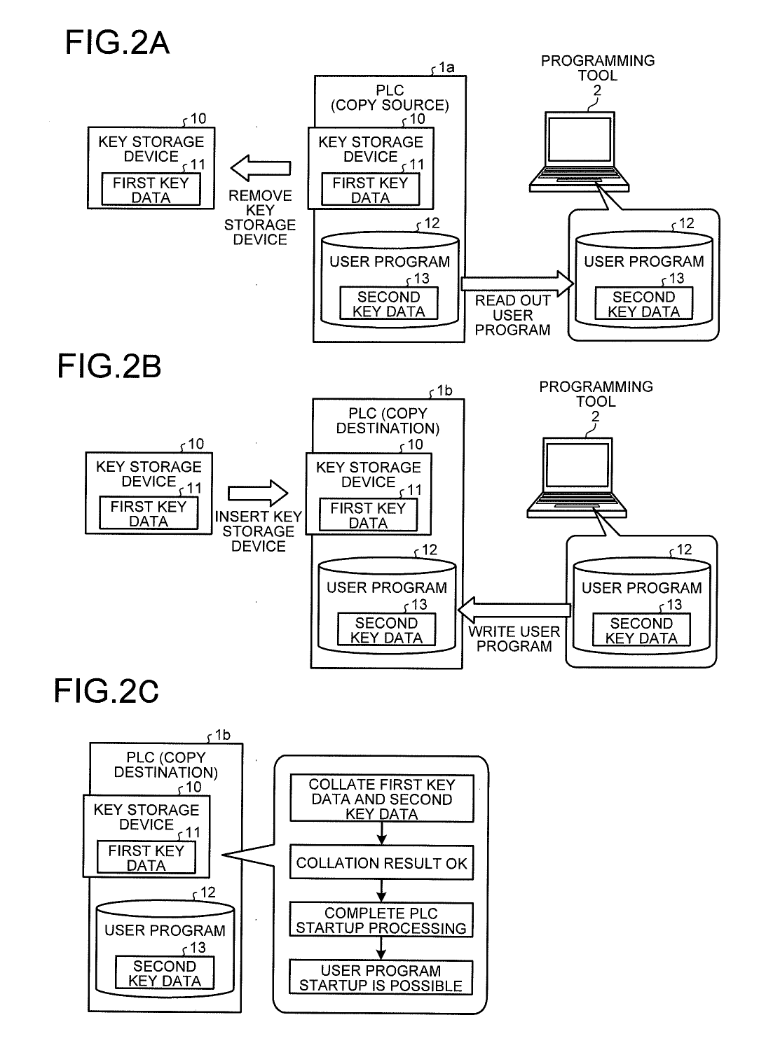

FIG. 2 is a diagram for explaining that the embodiment of the present invention has high maintainability. In the following explanation, the end user replaces the PLC 1a with the PLC 1b. First, as shown in FIG. 2(a), the end user removes the key storage device 10, which stores the first key data 11, from the PLC 1a and reads out the user program 12, which is incorporated in the PLC 1a, together with the second key data 13 using a programming apparatus (hereinafter, programming tool) 2. As shown in FIG. 2(b), the end user inserts the key storage device 10, which is removed from the PLC 1a, into the PLC 1b and writes the read-out user program 12 in the PLC 1b using the programming tool 2. When the end user turns on the power supply for the PLC 1b, the PLC 1b collates the first key data 11 and the second key data 13. The first key data 11 and the second key data 13 are respectively the same as the key data stored in the PLC 1a. Therefore, a collation result is OK. The PLC 1b can complete the PLC startup processing and shift to a state in which the startup of the user program 12 can be performed.

As explained above, according to the embodiment of the present invention, if the key storage device 10 is replaced and the user program 12 is copied, it is possible to cause another PLC 1 to execute the same control. Therefore, for example, when the PLC 1 has broken down, the end user can replace the PLC 1 in a short time. The PLC 1b prepared for replacement does not need to be a PLC in which hardware peculiar data is set in a predetermined address by the apparatus manufacturer (i.e., exclusively prepared by the apparatus manufacturer) unlike the technology disclosed in Patent Literature 1. The PLC 1b can be any PLC 1 as long as the PLC 1 includes the configuration to which the embodiment of the present invention can be applied. For example, the end user sometimes uses a plurality of the PLCs 1 that respectively execute different kinds of control. Even in that case, if one auxiliary PLC 1 is prepared, irrespective of which PLC 1 among the PLCs 1 breaks down, the PLC 1 can be replaced with the auxiliary PLC 1. The end user can easily replace the PLC 1 without inputting a password. In this way, in the embodiment of the present invention, maintainability for the end user is high.

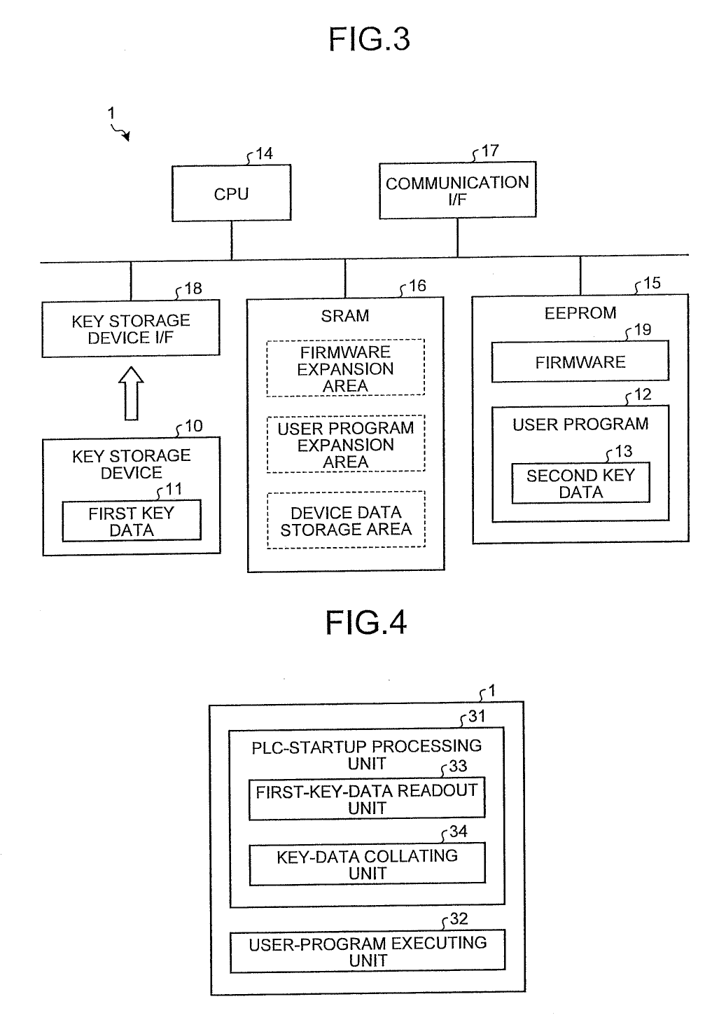

FIG. 3 is a diagram for explaining a hardware configuration of the PLC 1 explained above. As shown in the figure, the PLC 1 includes a CPU (Central Processing Unit) 14, an EEPROM (Electrically Erasable Programmable Read Only Memory) 15, an SRAM (Static Random Access Memory) 16, a communication interface (I/F) 17, and a key storage device I/F 18. The CPU 14, the EEPROM 15, the SRAM 16, the communication I/F 17, and the key storage device I/F 18 are connected to one another via a bus.

The key storage device I/F 18 is an interface for accessing the key storage device 10. The PLC 1 accesses the first key data 11, which is stored by the inserted key storage device 10, via the key storage device I/F 18.

As explained above, the first key data 11 stored by the key storage device 10 is set to disable the end user to read and write. A mechanism for disabling the end user to read and write the first key data 11 is configured to perform access to the key storage device 10 using an exclusive communication protocol (a communication protocol in which at least one of a physical condition of a transmission line, communication, specification of a partner, and information representation is exclusively designed) undisclosed to the end user.

The EEPROM 15 has stored therein the user program 12 embedded with the second key data 13 and firmware 19, which is a system program for the PLC 1.

In the SRAM 16, a firmware expansion area, a user program expansion area, and a device data storage area are secured. The firmware 19 is read out from the EEPROM 15 and expanded in the firmware expansion area of the SRAM 16. The CPU 14 executes, based on the firmware 19 expanded in the SRAM 16, a basic operation including the PLC startup processing for the PLC 1. After completing the PLC startup processing, when a RUN instruction from an operator is input via an input interface or a programmable display not shown in the figure, the CPU 14 starts up the user program 12 (user program startup processing). Specifically, as the user program startup processing, the CPU 14 reads out the user program 12 from the EEPROM 15, expands the user program 12 in the user program expansion area, and starts up the expanded user program 12. The CPU 14 generates device data for controlling an industrial machine based on the control by the user program 12 started up by the user program startup processing and stores the generated device data in the device data storage area of the SRAM 16.

The communication I/F 17 is a communication interface for executing communication with the programming tool 2.

FIG. 4 is a diagram for explaining the configuration of functions of the PLC 1 realized by the firmware 19 being executed by the CPU 14. As shown in the figure, the PLC 1 includes a PLC-startup processing unit 31 that executes the PLC startup processing and a user-program executing unit 32 that executes the user program startup processing. Further, the PLC-startup processing unit 31 includes a first-key-data readout unit 33 that accesses the key storage device 10 using the exclusive communication protocol and reads out the first key data 11 and a key-data collating unit 34 that collates the first key data 11 read out by the first-key-data readout unit 33 and the second key data 13 embedded in the user program 12 and determines, based on a collation result, whether the PLC startup processing is continued or the PLC startup processing is. stopped for abnormal processing to be executed.

The abnormal processing can be a processing for forcibly ending the PLC 1 or a processing for outputting a warning for the operator to the programmable display or the like after stopping the PLC startup processing.

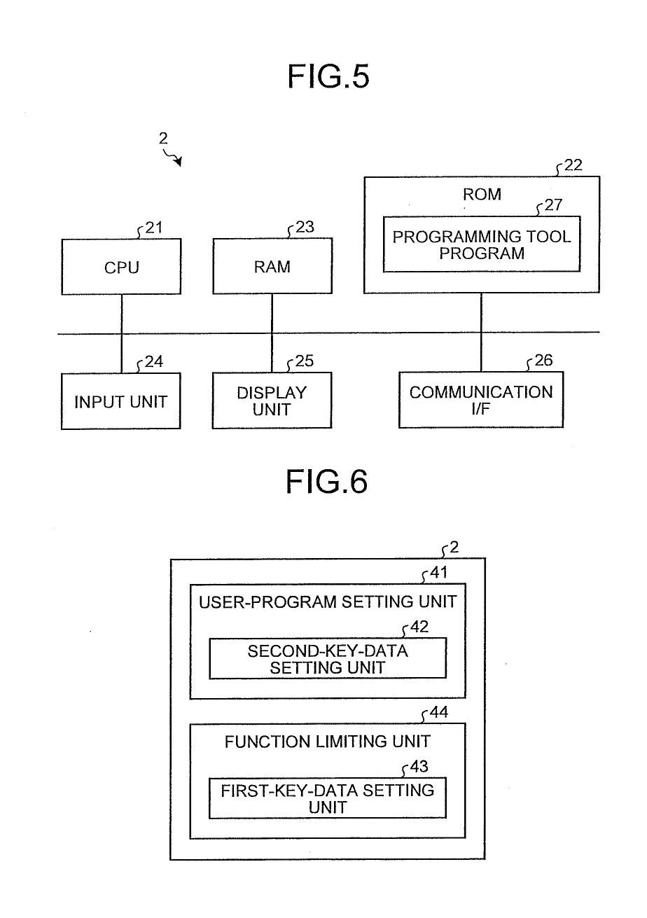

FIG. 5 is a diagram for explaining a hardware configuration of the programming tool 2. As shown in the figure, the programming tool 2 has a configuration equivalent to a general computer including a CPU 21, a ROM 22, a RAM 23, an input unit 24, a display unit 25, and a communication I/F 26. The CPU 21, the ROM 22, the RAM 23, the input unit 24, the display unit 25, and the communication I/F 26 are connected to one another via bus.

The CPU 21 executes a programming tool program 27, which is a computer program for realizing functions of the programming tool 2 explained later. The display unit 25 is a display device such as a liquid crystal monitor. The display unit 25 displays, based on an instruction from the CPU 21, output information to the operator such as an operation screen. The input unit 24 includes a mouse and a keyboard. Operation of the programming tool 2 from the operator is input to the input unit 24. Operation information input to the input unit 24 is sent to the CPU 21. The communication I/F 26 is a communication interface for executing communication with the PLC 1.

The programming tool program 27 is stored in the ROM 22 and loaded to the RAM 23 via the bus line. The CPU 21 executes the programming tool program 27 loaded in the RAM 23.

The programming tool program 27 can be stored in a storage device such as a disk. The programming tool program 27 can be loaded to the storage device such as the disk. The programming tool program 27 can be stored on a computer connected to a network such as the Internet and provided or distributed by being downloaded through the network. The programming tool program 27 executed by the programming tool 2 can be provided or distributed through the network such as the Internet. The programming tool program 27 can be incorporated in the ROM 22 or the like in advance and provided to the programming tool 2.

FIG. 6 is a diagram for explaining the configuration of functions of the programming tool 2 realized by the CPU 21 executing the programming tool program 27.

As shown in FIG. 6, the programming tool 2 includes a user-program setting unit 41 that creates the user program 12 based on operation by the operator, writes the created user program 12 in the EEPROM 15 included in the PLC 1, and reads out the user program 12 written in the EEPROM 15. The user-program setting unit 41 includes a second-key-data setting unit 42 that embeds the second key data 13 in the created user program 12.

The programming tool 2 includes a first-key-data setting unit 43 that accesses the key storage device 10 using the exclusive communication protocol and reads the first key data 11 from and writes the first key data 11 in the key storage device 10 and a function limiting unit 44 that limits (permits/does not permit) the use of the first-key-data setting unit 43 by the operator. As a limiting method by the function limiting unit 44, the function limiting unit 44 adopts a password authentication method for requesting an input of the first key data 11 stored by the access-target key storage device 10 serving as a password and permitting the use of the first-key-data setting unit 43 when the input password coincides with the first key data 11 stored by the key storage device 10. With such a password authentication method, it is possible to limit an operator who can access the key storage device 10 to only an operator (i.e., an apparatus manufacturer) who writes the first key data 11.

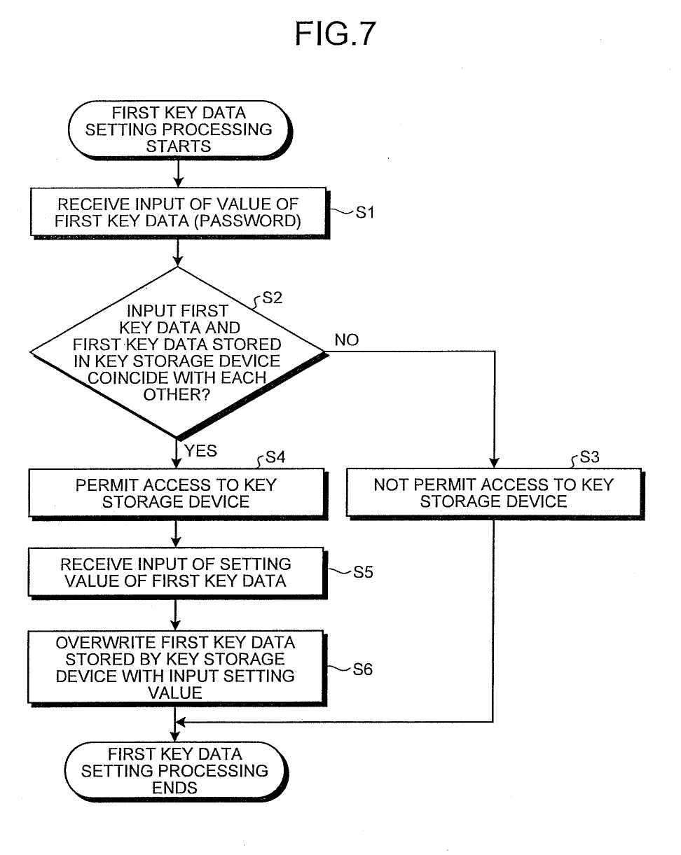

The operations of the PLC 1 and the programming tool 2 according to the embodiment of the present invention are explained. FIG. 7 is a flowchart for explaining an operation (first key data setting processing) in which the programming tool 2 is operated by the operator of the apparatus manufacturer and the first key data 11 is set. It is assumed that the first key data setting processing is executed in a state in which the PLC 1 inserted with the key storage device 10 and the programming tool 2 are connected.

When the function limiting unit 44 is started up and the first key data setting processing is started, as shown in FIG. 7, the function limiting unit 44 receives an input of the first key data 11 serving as a password (step S1). Then, the function limiting unit 44 accesses the key storage device 10 inserted in the PLC 1 via the first-key-data setting unit 43, reads out the first key data 11 stored by the key storage device 10, and determines whether the input first key data 11 and the read-out first key data 11 coincide with each other (step S2).

When both the first key data 11 do not coincide with each other (No at step S2), the function limiting unit 44 does not permit access to the key storage device 10 by the operator (step S3) and ends the first key data setting processing. When both the first key data 11 coincide with each other (Yes at step S2), the function limiting unit 44 permits access to the key storage device 10 by the operator, i.e., permits operation of the first key data setting unit 43 by the operator (step S4).

The first-key-data setting unit 43 receives an input of the first key data 11 serving as a new setting value from the operator (step S5). The first-key-data setting unit 43 overwrites the first key data 11 stored by the key storage device 10 with the input setting value of the first key data 11 (step S6). The first key data setting processing ends.

When the first key data 11 is set in the key storage device 10 in which the first key data 11 is not set, the first key data 11 can be able to be set without undergoing the password authentication at steps S1 to S4. In that case, it is desirable that, before step S1, the function limiting unit 44 determines whether the first key data 11 is not set, when the first key data 11 is not set, shifts to step S5, and, when the first key data 11 is set, shifts to step S1.

A PLC manufacturer ships the PLC 1 to the apparatus manufacturer in a state in which the first key data 11 as the initial value is set in the key storage device 10. At step S1, the apparatus manufacturer can input the initial value informed from the PLC manufacturer to thereby clear the password authentication.

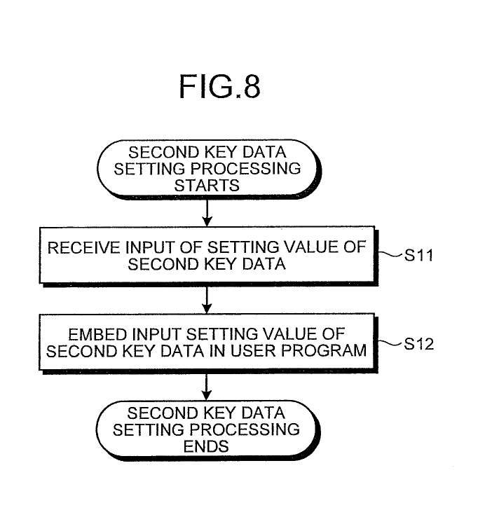

FIG. 8 is a flowchart for explaining an operation (second key data setting processing) in which the programming tool 2 is operated by the operator of the apparatus manufacturer and the second key data 13 is set. The programming tool 2 can be connected to the PLC 1 and the second key data can be directly set in the user program 12 stored in the EEPROM 15. The programming tool 2 can be not connected to the PLC 1 and the second key data can be set in the user program 12 stored in the data storage area of the RAM 23 of the programming tool 2 or stored in a not-shown external storage device.

As shown in FIG. 8, when the second-key-data setting unit 42 of the user-program setting unit 41 is started up and the second key data setting processing starts, first, the second-key-data setting unit 42 receives an input of a setting value of the second key data 13 from the operator (step S11). Then, the second-key-data setting unit 42 embeds the input setting value of the second key data 13 in the user program 12 (step S12). The second key data setting processing ends.

An embedding place of the second key data 13 in the user program 12 is undisclosed to the end user. The second-key-data setting unit 42 can apply obfuscation processing to the user program 12 to thereby make it difficult to specify the embedding place of the second key data 13. It is possible to obtain an effect for making unauthorized duplication of the PLC 1 more difficult by making it difficult to specify the embedding place of the second key data 13.

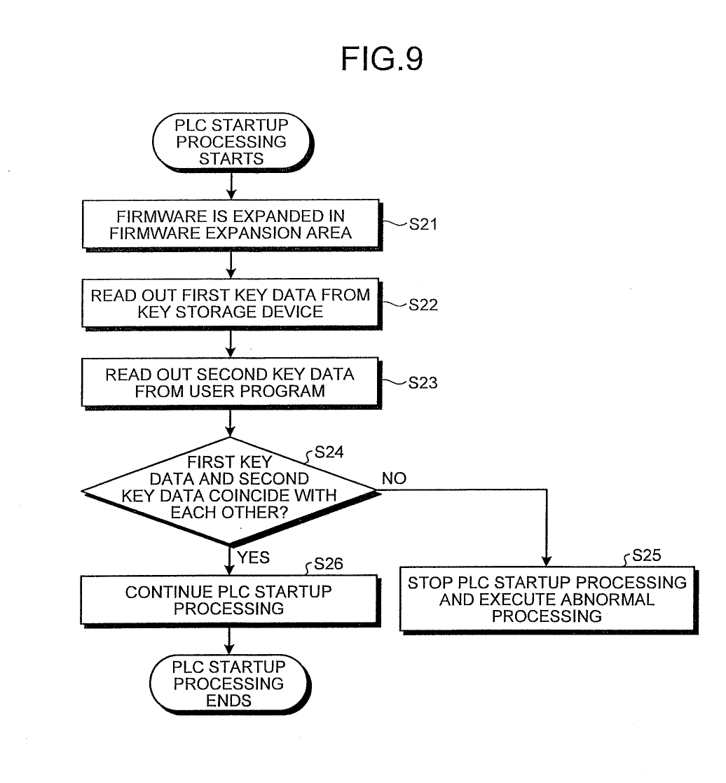

FIG. 9 is a flowchart for explaining the PLC startup processing. As shown in the figure, when the power supply for the PLC 1 is turned on and the PLC startup processing starts, first, the firmware 19 is expanded by the PLC-startup processing unit 31 in the firmware expansion area secured in the SRAM 16 (step S21). At step S21 and subsequent steps, the CPU 14 operates based on the firmware 19 expanded on the SRAM 16.

As a part of the PLC startup processing, the first-key-data readout unit 33 reads out the first key data 11 from the key storage device 10 inserted in the PLC 1 (step S22). The key-data collating unit 34 reads out the second key data 13 embedded in the user program 12 (step S23). The key-data collating unit 34 determines whether the first key data 11 read out by the first-key-data readout unit 33 and the second key data 13 embedded in the user program 12 coincide with each other (step S24).

When the first key data 11 and the second key data 13 do not coincide with each other (No at step S24), the PLC-startup processing unit 31 stops the PLC startup processing and executes the abnormal processing (step S25).

On the other hand, when the first key data 11 and the second key data 13 coincide with each other (Yes at step S24), the PLC-startup processing unit 31 continues the PLC startup processing (step S26). The PLC startup processing is completed.

The above explanation exemplifies a case where the key-data collating unit 34 determines that a collation result is OK when the first key data 11 and the second key data 13 are equal. However, a predetermined conversion algorithm can be provided in the key-data collating unit 34. The key-data collating unit 34 can apply the conversion algorithm to convert one or both the key data and determine that collation is OK when the key data after the application of the conversion algorithm coincide with each other.

In the above explanation, the function limiting unit 44 permits or does not permit the use of the first-key-data setting unit 43 using the first key data 11, which is stored by the access-target key storage device 10, as the password. The password used by the function limiting unit 44 is not limited to the first key data 11 alone. For example, data used as the password can be stored in the key storage device 10 besides the first key data 11. The function limiting unit 44 can receive an input of the data stored by the access-target key storage device 10. A combination of the data and the first key data 11 can be used as the password used for the collation.

In the above explanation, the first key data setting processing is executed in the state in which the PLC 1, in which the key storage device 10 is inserted, and the programming tool 2 are connected. However, a key storage device I/F can be provided in the programming tool 2 as well and the first key data setting processing can be executed via the key storage device I/F. The key storage device I/F can be a USB memory or can be exclusively-designed hardware.

As explained above, according to the embodiment of the present invention, when the power supply is turned on, the PLC 1 reads out the first key data 11 stored by the detachable key storage device 10 inserted in the PLC itself and protected from access and the second key data 13 associated with the user program 12 stored by the EEPROM 15, collates the read-out first key data 11 and the read-out second key data 13, and determines, based on a collation result, whether the PLC startup processing is continued or the PLC startup processing is stopped for the abnormal processing to be executed. Therefore, it is possible to obtain a PLC that has as high maintainability as possible and can prevent unauthorized apparatus duplication.

The programming tool 2 is configured to include the first-key-data setting unit 43 that reads and writes the first key data 11 stored in the key storage device 10, the function limiting unit 44 that permits or does not permit the operation of the first-key-data setting unit 43 by the user, and the second-key-data setting unit 42 that receives the input of the second key data 13 by the user and associates the received second key data 13 with the user program 12. Therefore, because it is difficult for a user other than the apparatus manufacturer to set the first key data, it is possible to prevent unauthorized apparatus duplication of the PLC 1.

### INDUSTRIAL APPLICABILITY

As explained above, the PLC and the programming apparatus according to the present invention are suitably applied to a PLC that controls an industrial machine based on a user program and a programming apparatus that creates the user program.

### REFERENCE SIGNS LIST

1 PLC
2 programming tool
10 key storage device
11 first key data
12 user program
13 second key data
14 CPU
15 EEPROM
16 SRAM
17 communication I/F
18 key storage device I/F
19 firmware
21 CPU
22 ROM
23 RAM
24 input unit
25 display unit
26 communication I/F
27 programming tool program
31 PLC-startup processing unit
32 user-program executing unit
33 first-key-data readout unit
34 key-data collating unit
41 user-program setting unit
42 second-key-data setting unit
43 first-key-data setting unit
44 function limiting unit

1-10. (canceled)

11. A programmable controller (PLC) that controls an industrial machine based on a user program, the programmable controller comprising:
a detachable first storing unit in which first key data is written in a state in which a user is limited by a programming apparatus including a function limiting unit that limits the user, the first storing unit being protected from access;
a second storing unit in which the user program is written by the programming apparatus in association with second key data; and
a startup processing unit configured to execute startup processing for the PLC itself when a power supply is turned on, wherein
the startup processing unit includes a startup-processing-stop determining unit configured to read out the first key data stored by the first storing unit inserted in the PLC itself and the second key data associated with the user program stored in the second storing unit and to determine, based on collation of the read-out two key data, whether the startup processing is continued or the startup processing is stopped for abnormal processing to be executed.

12. The programmable controller according to claim 11, wherein
the startup-processing-stop determining unit determines, when the read-out two key data coincide with each other, that the startup processing is continued and determines, when the read-out two key data do not coincide with each other, that the startup processing is stopped for the abnormal processing to be executed.

13. The programmable controller according to claim 11, wherein
the first storing unit is protected from access by requiring an exclusive communication protocol for the access.

14. The programmable controller according to claim 11, wherein
the second key data is associated with the user program by being embedded in the user program and stored in the second storing unit.

15. The programmable controller according to claim 14, wherein
the user program embedded with the second key data is obfuscated.

16. The programmable controller according to claim 11, wherein
the programming apparatus further includes:
a first-key-data setting unit configured to read and write the first key data stored in the first storing unit; and
a second-key-data setting unit configured to receive an input of the second key data by the user and associate the received second key data with the created user program, and
the function limiting unit permits or does not permit operation of the first-key-data setting unit by the user.

17. The programmable controller according to claim 16, wherein,
when the user updates the first key data stored in the first storing unit, the function limiting unit receives an input of a password from the user and permits or does not permit the operation of the first-key-data setting unit based on the received password.

18. The programmable controller according to claim 17, wherein
the function limiting unit determines whether the received password and the first key data stored in the first storing unit coincide with each other, permits the operation of the first-key-data setting unit when the received password and the first key data stored in the first storing unit coincide with each other, and does not permit the operation of the first-key-data setting unit when the received password and the first key data stored in the first storing unit do not coincide with each other.

19. The programmable controller according to claim 16, wherein
the second-key-data setting unit associates the received second key data with the created user program by embedding the received second key data in the created user program.

20. The programmable controller according to claim 19, wherein
the second-key-data setting unit obfuscates the user program associated with the received second key data.
